(19) United States
(12) Patent Application Publication
(10) Pub. No.: US 2022/0414564 A1
(43) Pub. Date: Dec. 29, 2022

(54) VECTOR TRANSFORMATION AND ANALYSIS FOR SUPPLY CHAIN EARLY WARNING SYSTEM

(71) Applicant: Microsoft Technology Licensing, LLC, Redmond, WA (US)

(72) Inventors: Shashank Shekhar CHIRANEWALA, Kirkland, WA (US); Eithon Michael Galinato CADAG, Seattle, WA (US); Arushi AGARWAL, Seattle, WA (US)

(21) Appl. No.: 17/356,165

(22) Filed: Jun. 23, 2021

(51) Int. Cl. G06Q 10/06; G06Q 30/02; G06F 16/2455; G06N 5/04

(52) U.S. Cl. CPC G06Q 10/0639; G06Q 30/0201; G06Q 10/06315; G06F 16/24564; G06N 5/04

(57) ABSTRACT

In non-limiting examples of the present disclosure, systems, methods and devices for identifying supply chain issues are presented. A first supply chain dataset comprising a plurality of supply chain dimensions may be received. A subset of the dataset may be transformed into plurality of supply chain vectors. A temporal moving average plot may be generated for each supply chain vector in a subset of the plurality of supply chain vectors. A set of rules may be applied to each temporal moving average plot to determine a performance value for each corresponding supply chain vector in the subset. A determination may be made that a performance value for a specific one of the supply chain vectors is below a threshold value. An interactive user interface that indicates the performance value for the specific supply chain vector is below the threshold value may be displayed.

### BACKGROUND

Large supply chains involve many different layers and variables that may affect the timeliness of supply chain milestones. For example, large supply chains typically include products, product manufacturers, product suppliers, product shippers, regional warehouses, and product endpoints. Each of these components may be associated with many different dimensions which may impact the timeliness of supply chain milestones. Because of the number of dimensions and variables included in supply chains it is difficult to ascertain what the cause of delays may be. This makes it difficult to remedy existing supply chain timeliness degradation. Not being able to identify the cause of supply chain delays also makes it challenging to determine which entities to place orders with to fill existing and projected demand.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for identifying supply chain issues using transformed supply chain data. According to a first example, a computer-implemented method is provided. The computer-implemented method comprises receiving a first supply chain dataset in a first format, the first supply chain dataset comprising a plurality of supply chain dimensions; transforming a data subset of the first supply chain dataset into a second format comprising a plurality of supply chain vectors; generating a temporal moving average plot for each supply chain vector in a subset of the plurality of supply chain vectors; applying a set of moving average analysis rules to each temporal moving average plot to determine a performance value for each corresponding supply chain vector in the subset; determining, based on application of the set of moving average analysis rules, that a performance value for a specific one of the plurality of supply chain vectors in the subset of the plurality of supply chain vectors is below a threshold value; and causing an interactive user interface to be displayed, the interactive user interface indicating the performance value for the specific one of the plurality of supply chain vectors is below the threshold value.

According to an additional example, a system is provided. The system comprises a memory for storing executable program code; and a processor, functionally coupled to the memory, the processor being responsive to computer-executable instructions contained in the program code and operative to: receive a first supply chain dataset in a first format, the first supply chain dataset comprising a plurality of supply chain dimensions; transform a data subset of the first supply chain dataset into a second format comprising a plurality of supply chain vectors; generate a temporal moving average plot for each supply chain vector in a subset of the plurality of supply chain vectors; apply a set of moving average analysis rules to each temporal moving average plot to determine a performance value for each corresponding supply chain vector in the subset; determine, based on application of the set of moving average analysis rules, that a performance value for a specific one of the plurality of supply chain vectors in the subset of the plurality of supply chain vectors is below a threshold value; and cause an interactive user interface to be displayed, the interactive user interface indicating the performance value for the specific one of the plurality of supply chain vectors is below the threshold value.

According to an additional example, a computer-readable storage device is provided. The computer-readable storage device comprises executable instructions that, when executed by the processor, assist with identifying supply chain issues using transformed supply chain data, the computer-readable storage device including instructions executable by the processor for: receiving a first supply chain dataset in a first format, the first supply chain dataset comprising a plurality of supply chain dimensions; transforming a data subset of the first supply chain dataset into a second format comprising a plurality of supply chain vectors; generating a temporal moving average plot for each supply chain vector in a subset of the plurality of supply chain vectors; applying a set of moving average analysis rules to each temporal moving average plot to determine a performance value for each corresponding supply chain vector in the subset; determining, based on application of the set of moving average analysis rules, that a performance value for a specific one of the plurality of supply chain vectors in the subset of the plurality of supply chain vectors is below a threshold value; and causing an interactive user interface to be displayed, the interactive user interface indicating the performance value for the specific one of the plurality of supply chain vectors is below the threshold value.

### BRIEF DESCRIPTION OF THE DRAWINGS

Non-limiting and non-exhaustive examples are described with reference to the following figures:

FIG. 1 is a schematic diagram illustrating an example distributed computing environment for identifying supply chain issues using transformed supply chain data.

FIG. 2 is a block diagram illustrating a plurality of supply chain dimensions and a plurality of variables for each of the supply dimensions.

FIG. 3 is a block diagram illustrating a plurality of exemplary vectors that have been generated from a transformed supply chain dataset.

FIG. 4A illustrates a temporal moving average plot for a single supply chain vector.

FIG. 4B illustrates an interactive user interface comprised of the temporal moving average plot of FIG. 4A and an insight associated with the temporal moving average plot of FIG. 4A.

FIG. 4C illustrates a temporal moving average plot for a plurality of supply chain vectors.

FIG. 4D illustrates an interactive user interface comprised of the temporal moving average plot of FIG. 4C and an insight associated with the temporal moving average plot of FIG. 4C.

FIG. 5A illustrates a first set of moving average analysis rules 500A that may be applied for analyzing a temporal moving average plot comprised of one or more supply chain vectors where a faster moving average crosses a slower moving average from below to above in the positive y-axis of a temporal moving average plot.

FIG. 5B illustrates a second set of moving average analysis rules that may be applied for analyzing a temporal moving average plot comprised of one or more supply chain vectors where a faster moving average crosses a slower moving average from above to below in the positive y-axis of a temporal moving average plot.

FIG. 6 illustrates an exemplary user interface that may be generated and caused to be displayed by an early warning service.

FIG. 7 is an exemplary method for identifying supply chain issues using transformed supply chain data.

FIGS. 8 and 9 are simplified diagrams of a mobile computing device with which aspects of the disclosure may be practiced.

FIG. 10 is a block diagram illustrating example physical components of a computing device with which aspects of the disclosure may be practiced.

FIG. 11 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments and examples described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the claims.

Examples of the disclosure provide systems, methods, and devices for identifying supply chain issues using transformed supply chain data. Supply chain data may be received in a first format comprising a plurality of supply chain dimensions and transformed it into a second format comprising a plurality of supply chain vectors. The first format and the plurality of supply chain dimensions may be distributed across a plurality of tables and a plurality of files. Each supply chain vector that is generated may be associated with a demand identifier. A demand identifier may comprise one or more numbers, letters, characters, or a code, that identify an order or request for one or more products or services. For example, a demand identifier may comprise a number corresponding to an order for server clusters of a specific type at a specific data center. Once a demand identifier has been associated with its supply chain dimensions, values corresponding to the demand identifier may be inserted into one or more of those dimensions to thereby generate a plurality of supply chain vectors. In some examples, two or more vectors may transformed into one or more combined vectors.

A vector relationship model may be applied to the supply chain vectors. In some examples, the vector relationship model may comprise a linear regression model, a statistical enrichment test, a statistical hypothesis test, an information score model, and/or a classifier model. The vector relationship model may be applied to supply chain vectors with different dimensions and variables for those dimensions. The vector relationship model may thus be utilized to detect systemic and new issues in supply chains. The algorithmic approach (e.g., using a linear regression model, a statistical enrichment test, a statistical hypothesis test, an information score model, a classifier model) to detect vectors that are significant to measure may combine a plurality of seemingly independent vectors to create transformed vectors, which are impactful in understanding the interactions and impact on a supply chain. In some examples, the vector relationship model may output a performance score for each vector, or combined vector, corresponding to a deviance from a mean or median supply chain performance timeframe for a supply chain milestone.

A temporal moving average plot may be generated for each supply chain vector, or combined vector, that is determined to have a performance score that is above a threshold divergence from a mean or median supply chain performance timeframe for a supply chain milestone. Each temporal moving average plot may comprise, for a supply chain milestone, at least a first moving average with a first speed (e.g., a fast-moving average) and a second moving average with a second speed (e.g., a slow-moving average).

The temporal moving average plots may be analyzed via application of a plurality of moving average rules to determine a performance value for each corresponding supply chain vector, or combined vector. As an example, a first rule may dictate that if a relatively fast-moving average crosses from below to above a relatively slow-moving average in the positive y-axis range, this indicates the lateness for a corresponding supply chain milestone is increasing (e.g., timeliness is worsening). A second rule may dictate that if a relatively fast-moving average crosses from above to below a relatively slow-moving average in the positive y-axis range, this indicates the lateness for a corresponding supply chain milestone is decreasing (e.g., timeliness is improving). A third rule may dictate that if a relatively fast-moving average crosses from below to above a relatively slow-moving average in the negative y-axis range, this indicates the earliness for a corresponding supply chain milestone is decreasing (e.g., timeliness is improving). A fourth rule may dictate that if a relatively fast-moving average crosses from above to below a relatively slow-moving average in the negative y-axis range, this indicates the earliness is increasing (e.g., timeliness is worsening). Additionally, a large slope of a moving average is a stronger signal than a smaller slope.

Based on the analysis of the moving average plots, insights and recommendations may be generated and displayed. In examples, the insights and recommendations may be interacted with to cause operations that assist with remedying supply chain timeliness degradation to be executed.

The systems, methods, and devices described herein provide technical advantages for identifying significant factors that affect supply chain milestone timeliness. By transforming disparate supply chain data from different sources into vectors of one or more dimensions associated with demand identifiers, the mechanisms described herein provide the ability to analyze and identify relationships in supply chain data that were otherwise extremely time consuming, if not impossible, to determine. These vectors comprised of transformed supply chain data also allow for enhanced user interfaces for analyzing and identifying trends with distinct and combined supply chain vectors. For example, moving average plots may be generated and displayed in interactive user interfaces. The enhanced interactive user interfaces described herein may only be generated by first identifying impactful supply chain vectors through the application of vector relationship models to the transformed supply chain data. The user interfaces allow users to efficiently ascertain the identified node or nodes in a supply chain that are causing a delay, while also providing the ability to address those issues via automated or semi-automated actions that may be executed via user interface interactions.

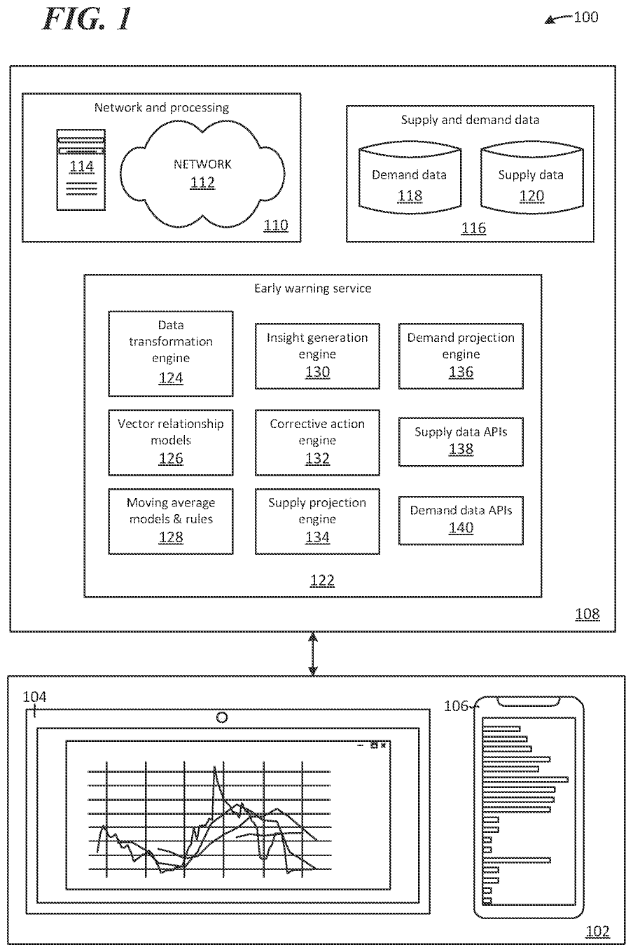

FIG. 1 is a schematic diagram illustrating an example distributed computing environment 100 for identifying supply chain issues using transformed supply chain data. Distributed computing environment 100 includes service sub-environment 108 and local device sub-environment 102. Early warning service 122 includes network and processing sub-environment 110, supply and demand data 116 and early warning service 122.

Network and processing sub-environment 110 includes server computing device 114 and network 112, via which any of the computing devices described herein may communicate with one another. Server computing device 114 is illustrative of one or more server computing devices that may host early warning service 122 and/or the supply chain data described in relation to supply and demand data 116 (e.g., demand data store 118, supply data store 120). Although early warning service 108 is illustrated as being included in service sub-environment 110, it should be understood that one or more components of early warning service 122 (e.g., engines, models, rules, APIs) may be stored on and/or executed by one of the local computing devices (e.g., client computing device 104, mobile computing device 106). Similarly, the local computing devices may execute applications, widgets, or add-ins associated with early warning service 122.

Supply and demand data 116 includes demand data store 118 and supply data store 120. In some examples, supply and demand data 116 may be associated with a reporting engine that automatically provides supply chain data to early warning service 122. Supply data store 120 may be associated with a plurality of nodes in a supply chain. As examples, a node in supply chain may comprise a product, a product supplier, a product manufacturer, a product shipper, a warehouse, or a product endpoint (e.g., a store, a data center). Each node, or layer, in a supply chain may provide data to supply chain data store 120. For example, a first node in a supply chain may correspond to a raw resources supplier, a second node in a supply chain may correspond to a manufacturer of a component in a device being manufactured, a third node in a supply chain may correspond to a shipper of a device being manufactured, a fourth node in a supply chain may correspond to a warehouse where a device is stored prior to being shipped to an endpoint (e.g., a datacenter), a fifth node may correspond to a shipper of a device from a warehouse to an endpoint, a sixth node may correspond to an endpoint where a device is going to be installed. Although supply and demand data 116 is primarily described herein as corresponding to data center supply and demand data, it should be understood that supply and demand data 116 may comprise data related to any product or service that includes a plurality of nodes in a supply chain.

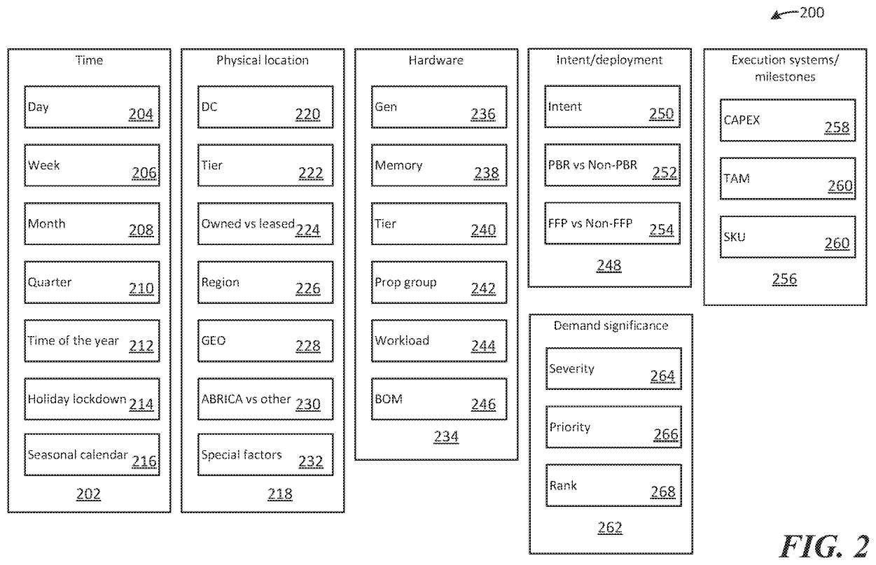

The supply chain data in supply data store 120 may be included in a plurality of tables and/or a plurality of files that are in a flat format (e.g., a database that stores data in a plain text format). In other examples, the supply chain data in supply data store 120 may be stored in a relational database. The supply chain data in supply data store 120 may comprise a plurality of supply chain dimensions. The supply chain dimensions that makeup the supply chain data in supply data store 120 are each related to a demand identifier. A demand identifier is a reference for a specific demand (e.g., a demand for a specific number and type of devices at a specific location on a specific date). Thus, for a data center demand identifier, supply chain dimensions may comprise time, physical location, hardware, intent/deployment, execution systems/milestones, and demand significance, among others, as more fully discussed below in relation to FIG. 2.

The demand data in demand data store 118 may also be included in a plurality of tables and/or a plurality of files that are in a flat format. In other examples, the demand data in demand data store 118 may be stored in a relational database. The demand data in demand data store 118 may comprise demand identifiers, past product and service orders, current product and service orders, and future product and service orders. In some examples, the demand data and the supply data included in supply and demand data 116 may be comprised in a single data store.

Early warning service 122 includes data transformation engine 124, vector relationship models 126, moving average models and rules 128, insight generation engine 130, corrective action engine 132, supply projection engine 134, demand projection engine 136, supply data APIs 138, and demand data APIs 140. Early warning service 122 may receive and/or retrieve data from supply chain data sub-environment 116.

Data transformation engine 124 may utilize supply data APIs 138 and demand data APIs 140 to obtain supply and demand data 116 from supply data store 120 and demand data store 118, respectively. In other examples, where supply and demand data 116 is associated with a reporting engine, the reporting engine may send supply and demand data 116 directly to early warning service 122 and/or data transformation engine 124. Data transformation engine 124 may receive a supply chain dataset in a first format (e.g., a flat format, from a plurality of tables, from a plurality of files) comprising a plurality of supply chain dimensions and transform it into a second format comprising a plurality of supply chain vectors. Each supply chain vector may be associated in the second format with a corresponding demand identifier. For example, data transformation engine 124 may identify a demand identifier (e.g., a demand identifier for a plurality of server clusters at a specific data center to be filled on a specific date) and associate a plurality of dimensions that correspond to the demand identifier with the demand identifier in single file. The dimensions may be identified from a plurality of files that makeup the supply chain dataset. For example, a first table in a first file from the supply chain dataset may include a first dimension associated with the demand identifier and a second table in a second file from the supply chain dataset may include a second dimension associated with the demand identifier. Depending on the demand identifier, the number of dimensions that are associated with the demand identifier may be tens, hundreds, or thousands. In some examples, data transformation engine 124 may execute one or more Structured Query Language (SQL) queries (e.g., key-based queries) on supply and demand data 116 to identify and extract the dimensions that are associated with the demand identifier.

Once data transformation engine 124 has associated a demand identifier with its supply chain dimensions, it may insert values corresponding to the demand identifier into one or more of those dimensions and thereby generate a plurality of supply chain vectors. In some examples, data transformation engine 124 may combine two or more vectors into one or more combined vectors. For example, data transformation engine 124 may generate a first vector comprised of a demand identifier, a datacenter region corresponding to that demand identifier, and a manufacturer associated with that demand identifier, and a second vector comprised of the demand identifier, and a specific warehouse associated with the demand identifier. The data transformation engine may combine those two vectors into a single vector comprised of the demand identifier, the datacenter region corresponding to the demand identifier, the manufacturer associated with the demand identifier, and the specific warehouse associated with the identifier. Data transformation engine 124 may generate hundreds, thousands, or even millions of supply chain vectors that are associated with as single demand identifier because of the number of dimensions that may be associated with the demand identifier. Similarly, supply and demand data 116 may comprise hundreds, thousands, or millions of demand identifiers, and as such, a single dimension (e.g., a factory, a manufacturer, a hardware type, a time) may be associated with a large subset of those hundreds, thousands, or millions of demand identifiers. Thus, manually sorting through and identifying relationships amongst the dimensions and demand identifiers that lead to supply chain degradation is not feasible.

Early warning service 122 may apply vector relationship models 126 to supply chain vectors generated by data transformation engine 124. Vector relationship models 126 may comprise one or more linear regression models, statistical enrichment tests, statistical hypothesis tests, information score models, and/or classifier models. Early warning service 122 may determine from analysis of the vectors generated by data transformation engine 124 that one or more specific dimensions are related to degraded supply chain performance (e.g., late delivery, late installation, late service performance), and one or more vector relationship models may be applied to supply chain data. The one or more vector relationship models may be applied to supply chain vectors with different dimensions and variables related to the one or more specific dimensions. In this manner, vector relationship models 126 may analyze hundreds, thousands, or even millions of vectors to determine which dimensions and corresponding variables are the most likely candidates leading to supply chain degradation. In some examples, vector relationship models 126 may output a performance score for each vector, or combined vector, corresponding to a deviance from a mean or median supply chain performance timeframe for a supply chain milestone (e.g., time to manufacture component, time to ship component, time to server cluster installation, time to dock). For example, installation of a server cluster at a specific data center may have a mean or median duration of time that is expected based on historical data. Similarly, manufacture of a component of a device by a particular manufacturer may have a mean of median duration of time that is expected based on historical data.

In some examples, early warning service 122 may generate a temporal moving average plot for each supply chain vector, or combined vector, that is determined to have a performance score that is above a threshold divergence from a mean or median supply chain performance timeframe for a supply chain milestone. In some examples, the threshold may vary from supply chain milestone to supply chain milestone. In other examples, the threshold may be the same for one or more supply chain milestones. Each temporal moving average plot may comprise, for a supply chain milestone, at least a first moving average with a first speed (e.g., a fast-moving average) and a second moving average with a second speed (e.g., a slow-moving average). In some examples, each temporal moving average plot may comprise tens, hundreds, or even thousands of different moving averages (e.g., different speeds of averages) for a supply chain milestone.

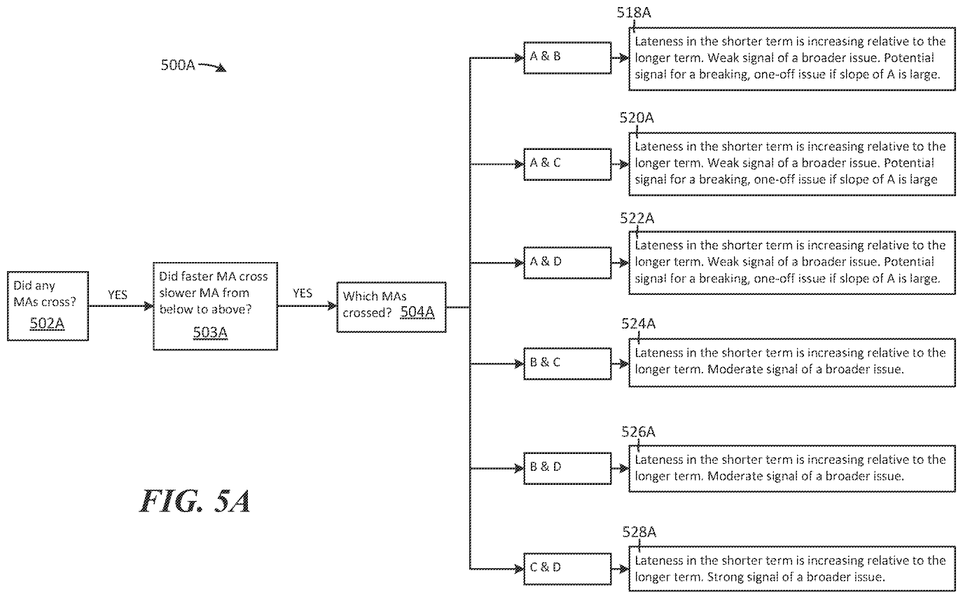

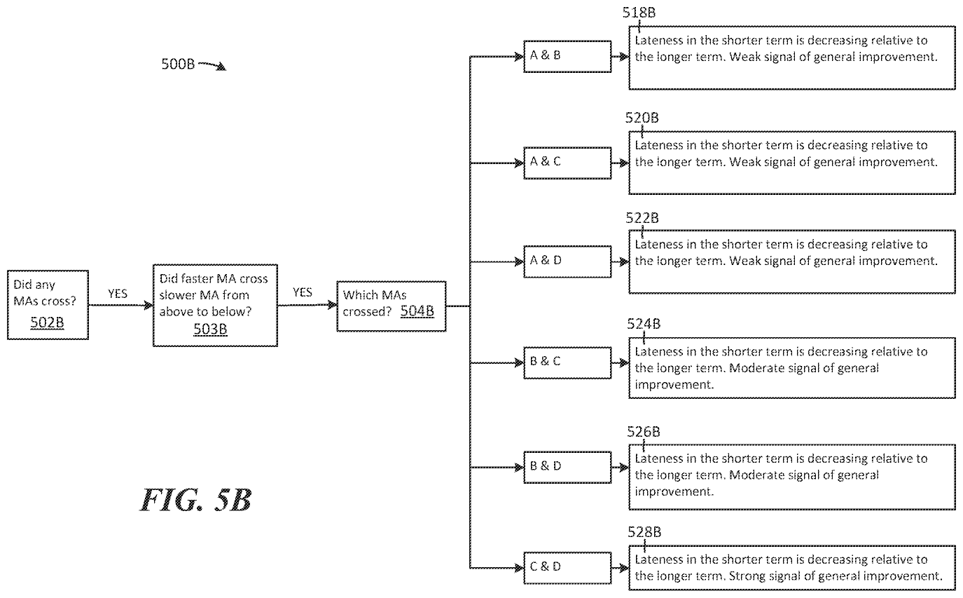

Early warning service 122 may apply moving average models and rules 128 to each temporal moving average plot to determine a performance value for each corresponding supply chain vector, or combined vector. As an example, a first rule may dictate that if a relatively fast-moving average crosses from below to above a relatively slow-moving average in the positive y-axis range, this indicates the lateness for a corresponding supply chain milestone is increasing (e.g., timeliness is worsening). A second rule may dictate that if a relatively fast-moving average crosses from above to below a relatively slow-moving average in the positive y-axis range, this indicates the lateness for a corresponding supply chain milestone is decreasing (e.g., timeliness is improving). A third rule may dictate that if a relatively fast-moving average crosses from below to above a relatively slow-moving average in the negative y-axis range, this indicates the earliness for a corresponding supply chain milestone is decreasing (e.g., timeliness is worsening). A fourth rule may dictate that if a relatively fast-moving average crosses from above to below a relatively slow-moving average in the negative y-axis range, this indicates the earliness is increasing (e.g., timeliness is improving). Additionally, a large slope of a moving average is a stronger signal than a smaller slope. Additional details related to moving average models and rules 128 are provided below in relation to FIGS. 5A and 5B.

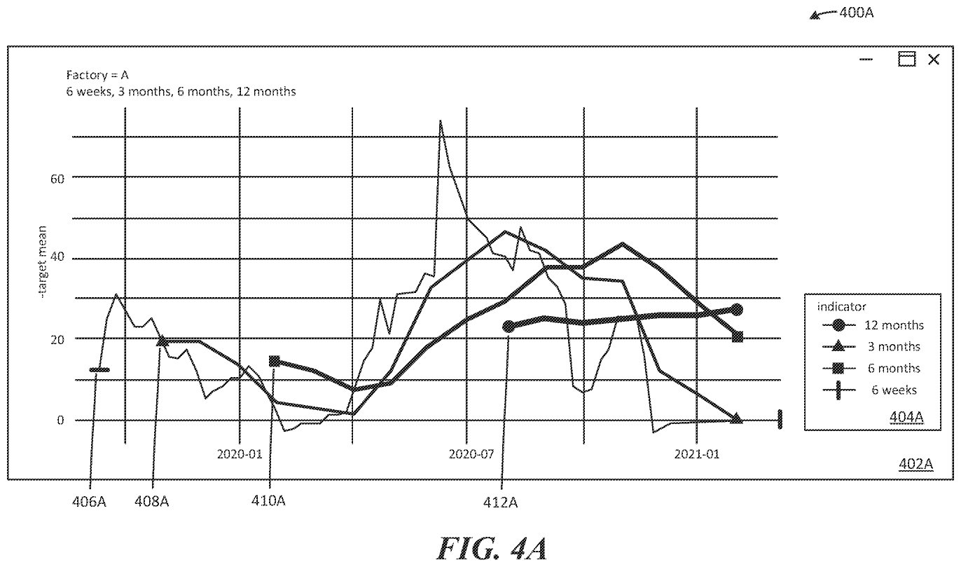

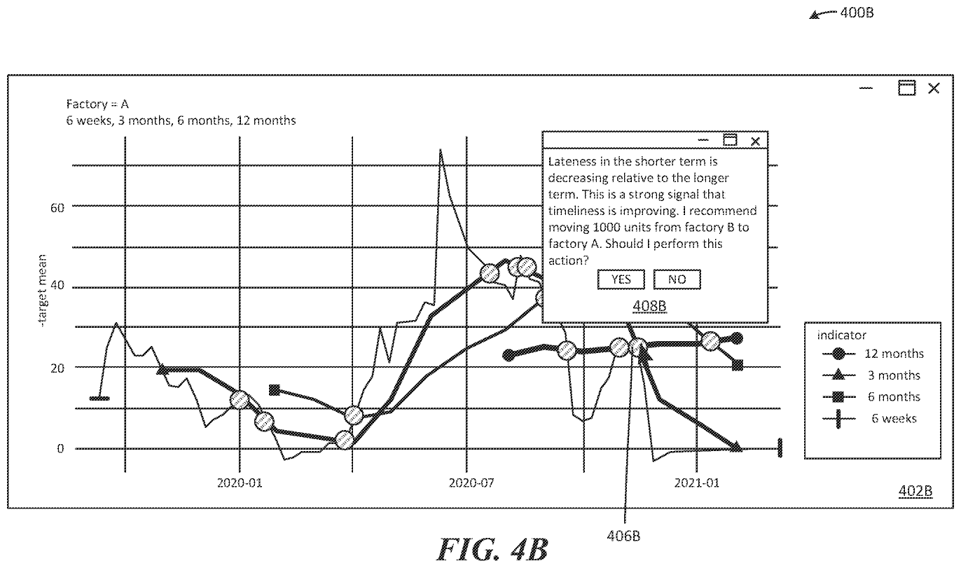

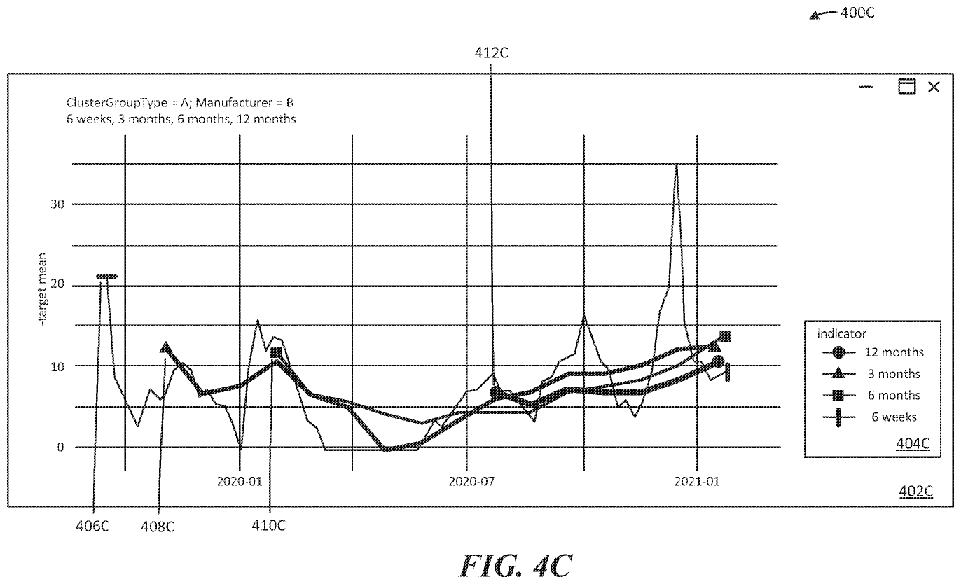

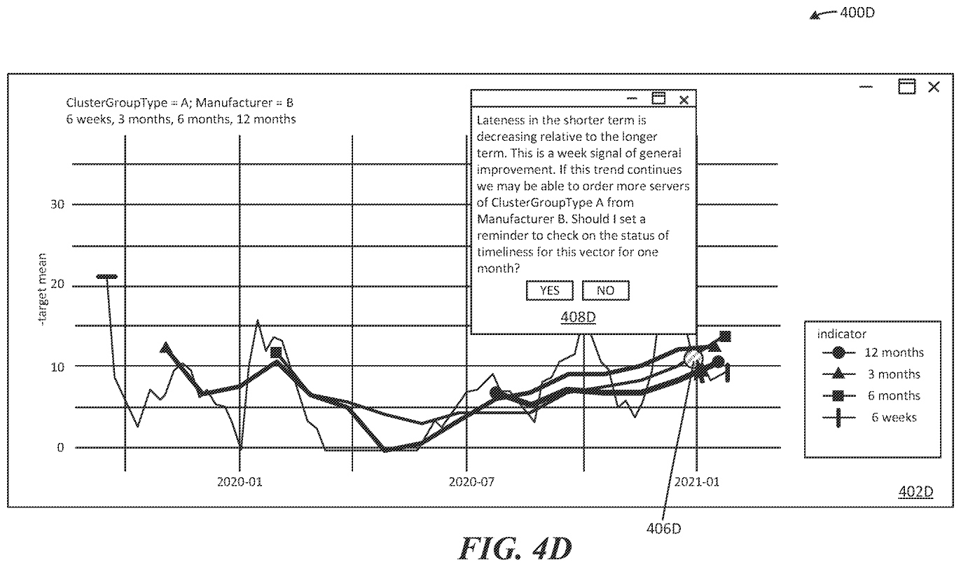

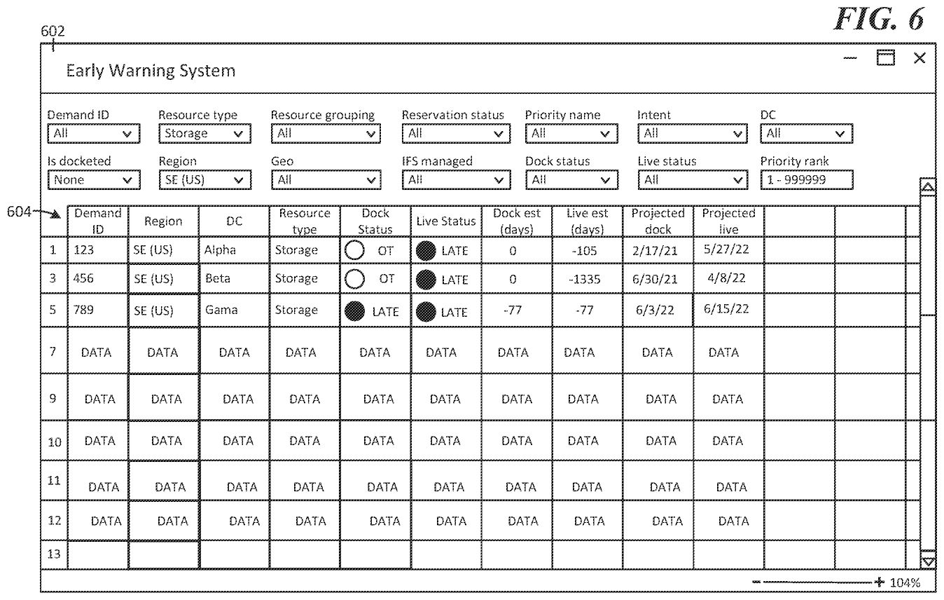

Based on the analysis performed by moving average models and rules 128, insight generation engine 130 may generate one or more insights related to one or more vectors, or combined vectors, and their associated temporal moving average plot(s) that have been determined to affect the timeliness of a supply chain milestone. In some examples, an insight may comprise a temporal moving average plot for a vector and a description of one or more datapoints that have been determined to be a cause or likely cause of a degradation in timeliness related to a supply chain milestone. In other examples, an insight may be caused to be displayed on a user interface of a local computing device, such as illustrated by client computing device 104 and more fully described in relation to FIG. 4B, FIG. 4D, and FIG. 6. In some examples, the user interface that includes the insight may be an interactive user interface. For example, a user may interact with a portion (e.g., an intersection of moving averages, a slope of a moving average) of a displayed moving average plot, and a description of that portion's relevance to supply chain timeliness may be caused to be generated and displayed by insight generation engine 130. In additional examples, an insight may comprise a graphical indication of a plurality of vectors, or combined vectors, that have been determined to affect the timeliness of a supply chain milestone. The graphical illustration may comprise a number of graphical elements that each indicate a number of dimensions that were determined to affect a particular supply chain milestone.

Corrective action engine 132 may execute one or more operations for remedying the lateness associated with a supply chain milestone based on the analysis performed by moving average models and rules 128. For example, if determination is made that a particular manufacturer corresponding to a supply chain dimension for a server cluster installation is the likely cause of a delay, corrective action engine 132 may automatically order components from a different manufacturer. In other examples, corrective action engine 132 may cause a selectable remedial action user interface element (e.g., a button, a link, a dropdown menu) to be displayed on a user interface of one or more user accounts or devices associated with a supply chain manager or supply chain employee, and one or more selectable remedial actions may be executed upon interaction with the selectable remedial action user interface element.

In some examples, rather than simply analyzing current and historical data for a supply chain and identifying supply chain deficiencies from that current and historical data (e.g., via data transformation engine 124, via vector relationship models 126, via moving average models and rules 128), early warning service 122 may make supply chain timeliness projections using supply projections and demand projections. For example, supply projection engine 134 may make projections regarding manufacturing timeliness, shipping timeliness, and/or installation timeliness based on one or more demand projection models (e.g., weather projection models, economical projection models). Similarly, demand projection engine 136 may make projections regarding raw material demand, component demand, device demand, and/or service demand based on one or more demand projection models (economical projection models, historical projection models, backorder projection models, inventory planning models). Based on this data, vectors for current and projected future demand may be intelligently identified and analyzed by early warning service 122.

FIG. 2 is a block diagram 200 illustrating a plurality of supply chain dimensions and a plurality of variables for each of the supply dimensions. The illustrated supply chain dimensions and their associated variables in this example correspond to a demand identifier for a data center demand (e.g., demand for one or more server clusters). However, it should be understood that different supply chain dimensions may be associated with different types of demand identifiers. For example a demand identifier for an order of cars for a car manufacturer would have different dimensions and variables than a demand identifier for an order of bananas for a grocery store. Additionally, although there are six dimensions illustrated in this example for the demand identifier corresponding to the data center demand, it should be understood that more dimensions (e.g., tens of dimensions, hundreds of dimensions, thousands of dimensions) or fewer dimensions (five dimensions, four dimensions) may be associated with the demand identifier corresponding to the data center demand, or a demand identifier for other types of demands (e g, manufacturing demand, big box store demand, grocery store demand) Additionally, the number of variables and the types of variables for each dimension may be greater or fewer than illustrated.

Block diagram 200 includes time dimension 202, physical location dimension 218, hardware dimension 234, intent/deployment dimension 248, execution systems/milestones dimension 256, and demand significance dimension 262.

Time dimension includes day variable 204, week variable 206, month variable 208, quarter variable 210, time of the year variable 212, holiday lockdown variable 214, and seasonal calendar variable 216.

Physical location dimension 218 includes data center variable 220, tier variable 222, owned vs leased variable 224, region variable 226, GEO variable 228, ABRICA vs other variable 23, and special factors variable 232.

Hardware dimension 234 includes generation variable 236, memory variable 238, tier variable 240, property group variable 242, workload variable 244, and BOM variable 246.

Intent/deployment dimension 248 includes intent variable 250, PBR vs Non-PBR variable 252, and FFP vs Non-FFP variable 254.

Execution systems/milestones dimension 256 includes CAPEX variable 258, TAM variable 260, and SKU variable 260.

Demand significance dimension 262 includes severity variable 264, priority variable 266, and rank variable 268.

Data transformation engine 124 may receive a demand identifier and identify and extract the dimensions (e.g., time dimension 202, physical location dimension 218, hardware dimension 234, intent/deployment dimension 248, execution system/milestones dimension 256, demand significance dimension 262) associated with the demand identifier from one or more tables and or files of supply and demand data 116. Data transformation engine 124 and/or vector relationship models 126 may then generate one or more supply chain vectors for the demand identifier by inserting values corresponding to the demand identifier for one or more variables into one or more of the demand identifiers. In some examples, a vector may be comprised of a single variable and a single dimension (e.g., physical location dimension 218, data center variable 220). In other examples, a vector may be comprised of multiple variables and a single dimension (e.g., physical location dimension 218, data center variable 220, tier variable 222). In still other examples, a vector may be comprised of a variable for each of a plurality of dimensions (e.g., month variable 208 for time dimension 202, region variable 226 for physical location dimension 218, workload variable 244 for hardware dimension 234). In additional examples, a vector may be comprised of multiple variables for each of a plurality of dimensions (e.g., data center variable 220 and tier variable 222 for physical location dimension 218, with generation variable 236 and memory variable 238 for hardware dimension 234). These operations may be performed iteratively for each demand identifier, or a subset of demand identifiers, going back a threshold duration of time (e.g., all demand identifiers for the last year, all demand identifiers for the last three months, half of all demand identifiers for the last year, half of all demand identifiers for the last six months).

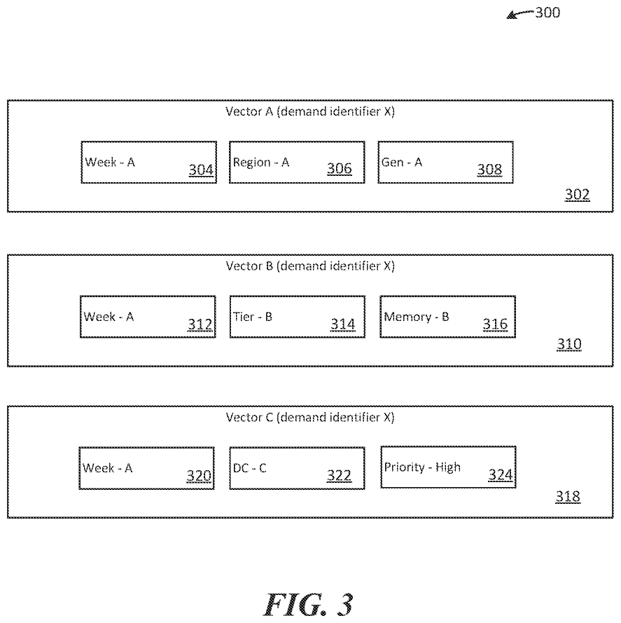

FIG. 3 is a block diagram 300 illustrating a plurality of exemplary vectors that have been generated from a transformed supply chain dataset. Block diagram 300 includes vector A 302, vector B 310, and vector C 318. Each of those vectors is associated with a same demand identifier (e.g., demand identifier X). However, it should be understood that the systems described herein generate a plurality of vectors for each of many different demand identifiers.

Vector A 302 comprises temporal value 304 (“week A”) corresponding to week variable 206 and time dimension 202, locational value 306 (“region A”) corresponding to region variable 226 and physical location dimension 218, and hardware value 308 (“generation A”) corresponding to generation variable 236 and hardware dimension 234.

Vector B 310 comprises temporal value 312 (“week A”) corresponding to week variable 206 and time dimension 202, locational value 314 (“tier B”) corresponding to tier variable 222 and physical location dimension 218, and hardware value 316 (“memory B”) corresponding to memory variable 238 and hardware dimension 234.

Vector C 318 comprises temporal value 320 (“week A”) corresponding to week variable 206 and time dimension 202, locational value 322 (“data center C”) corresponding to data center variable 220 and physical location dimension 234, and demand significance value 324 (“priority high”) corresponding to priority variable 266 and demand significance dimension 262.

FIG. 4A illustrates a temporal moving average plot 400A for a single supply chain vector. Temporal moving average plot 400A is displayed on user interface 402A. Temporal moving average plot 400A comprises four moving averages for a specific factory vector (“factory A”). The four moving averages are a 6-week moving average 406A, a 3-month moving average 408A, a 6-month moving average 410A, and a 12-month moving average 412A. The moving averages correspond to a supply chain milestone. In this example, the supply chain milestone corresponds to a server cluster time to dock. However, it should be understood that temporal moving average plots may be generated for other supply chain milestones for data center supply chains, and for other types of supply chains. For example, in the case of data center supply chains, temporal moving average plots may be generated for a live server milestone, a shipping milestone, and/or a manufactured milestone. Similarly, for a grocery store, temporal moving average plots may be generated for a shipping milestone, an arrival milestone, and/or a stocking milestone, for example.

Temporal moving average plot 400A may have been generated by data transformation engine 124 based on a determination that the performance score for the corresponding vector (the factory A vector) is above a threshold divergence from a mean or median supply chain performance timeframe for a supply chain milestone. Although temporal moving average plot 400A displays four moving averages in this example, it should be understood that data transformation engine 124 may generate more or fewer moving averages for a vector, and those more or fewer moving averages may be caused to be displayed on a user interface.

User interface 402A displays the positive y-axis of temporal moving average plot 400A. User interface 402A may be scrolled or otherwise adjusted to other portions (e.g., negative y-axis) of moving average plot 400A. The y-axis of moving average plot 400A corresponds to the target mean for a supply chain milestone. For example, the 0 on the y-axis may correspond to the mean or median number of days for hitting the milestone in the supply chain for locations (e.g., data centers, regions) served by factory A. The 20 on the y-axis may correspond to being 20 days over (e.g., late) from the mean or median number of days for hitting the milestone, the 40 on the y-axis may correspond to being 40 days over from the mean or median number of days for hitting the milestone, and the 60 on the y-axis may correspond to being 60 days over from the mean or median number of days for hitting the milestone.

The units on the x-axis correspond to dates. Specifically, each consecutive line on the x-axis corresponds to 1.5 months. There is a displayed date indicator on the second vertical line corresponding to January 2020, a displayed date indicator on the fourth vertical line corresponding to July 2020 and a displayed date indicator on the sixth vertical line corresponding to January 2021.

User interface 402A also includes indicator key 404A, which indicates that 6-week moving average 406A includes vertical indicators on moving average plot 400A, 3-month moving average 408A includes triangular indicators on moving average plot 400A, 6-month moving average 410A includes square indicators on moving average plot 400A, and 12-month moving average 412A includes circular indicators on moving average plot 400A. For ease of illustration, the thickness of the lines corresponding to the moving averages increases as the speed of moving average decreases (e.g., 12-month moving average 412A is the slowest moving average and has the thickest line, 6-week moving average 406A is the fastest moving average and has the thinnest line).

FIG. 4B illustrates an interactive user interface 402B comprised of the temporal moving average plot of FIG. 4A and an insight 408B associated with the temporal moving average plot of FIG. 4A.

In this example, temporal moving average plot 400B for the factory vector (“factory A”) includes a plurality of selectable user interface elements. Specifically, a selectable user interface element is displayed at each instance where a moving average crosses another moving average in temporal moving average plot 400B. In this example, the selectable user interface elements are circular objects with a diagonal line pattern. However, it should be understood the selectable user interface elements may be displayed in other shapes, colors, or patterns, for example. Additionally, in some examples, the selectable user interface elements may only be provided for one or a subset of moving average crossings on a moving average plot. Each selectable user interface element is selectable for causing an insight, such as insight 408B to be surfaced. The insight that is surfaced for a selectable user interface element corresponds to a description of one or more moving average analysis rules that have been applied to determine a performance value for a corresponding supply chain vector (e.g., the supply chain vector for factory A). Additional details regarding the moving average analysis rules are provided below in relation to FIGS. 5A and 5B.

In this example, an interaction is received at selectable user interface element 406B. The interaction may comprise a mouse click, a touch input, or a voice input, for example. The interaction causes insight 408B to be displayed. Selectable user interface element 406B is at a location on temporal moving average plot 400B where the second slowest moving average (the 6-month moving average) crosses the slowest moving average (the 12-month moving average) from above to below in the positive y-axis of temporal moving average plot 400B. The angle of the crossing is also relatively high (e.g., greater than 45 degrees). Moving average analysis rules provide that in this scenario, lateness in the shorter term is decreasing relative to the longer term, and this is a strong signal that timeliness is improving. Thus, insight 408 states: “Lateness in the shorter term is decreasing relative to the longer term. This is a strong signal that timeliness is improving.” Insight 408 also states “I recommend moving 1000 units from factory B to factory A. Should I perform this action?” There is also a selectable “YES” element for causing the action (e.g., causing 1000 units to be moved from factory B to factory A for manufacture) to be automatically performed by the system, and a selectable “NO” element for declining the recommendation. If the “YES” element is selected, early warning service 122 may execute cancellation and/or ordering operations through a supply chain order database. In additional examples, one or more objects displayed on or associated with interactive user interface 402B may be selectable for causing the identities of one or more locations (e.g., regions, data centers) that receive products (e.g., server clusters, server parts) from factory A to be displayed.

Thus, early warning service 122 may generate insights and recommendations that may be interacted with for causing actions to be performed that enhance the efficiency of a supply chain. Insight 408B and the included actionable recommendation is simply one example, and it should be understood that other recommendations and action types may be included in insights for factory vectors, as well as other types of vectors (e.g., regional vectors, temporal vectors, demand significance vectors, combined vectors). Additionally, different insight content and actionable recommendations may be generated and displayed based on the type and/or severity of moving average crossing that an insight and/or recommendation is generated for.

FIG. 4C illustrates a temporal moving average plot 400C for a plurality of supply chain vectors. That is, temporal moving average plot 400C is generated for combined vector comprising a server cluster group type vector (“ClusterGoupType A”) and a server manufacturer vector (“Manufacturer B”). Temporal moving average plot 400C comprises four moving averages for the combined vector. The four moving averages are a 6-week moving average 406C, a 3-month moving average 408C, a 6-month moving average 410C, and a 12-month moving average 412C. The moving averages correspond to a supply chain milestone. In this example, the supply chain milestone corresponds to a server cluster time to dock. However, it should be understood that temporal moving average plots may be generated for other supply chain milestones for data center supply chains, and for other types of supply chains.

Temporal moving average plot 400C may have been generated by data transformation engine 124 based on a determination that the performance score for the combined vector of ClusterGroupType A vector and Manufacturer B vector is above a threshold divergence from a mean or median supply chain performance timeframe for a supply chain milestone. Although temporal moving average plot 400C displays four moving averages in this example, it should be understood that data transformation engine 124 may generate more or fewer moving averages for a vector, and those more or fewer moving averages may be caused to be displayed on a user interface.

User interface 402C displays the positive y-axis of temporal moving average plot 400C. User interface 402C may be scrolled or otherwise adjusted to other portions (e.g., negative y-axis) of moving average plot 400C. The y-axis of moving average plot 400C corresponds to the target mean for a supply chain milestone. For example, the 0 on the y-axis may correspond to the mean or median number of days for hitting the milestone in the supply chain for locations (e.g., data centers, regions) that receive server clusters of ClusterGroupType A manufactured by Manufacturer B. The 10 on the y-axis may correspond to being 10 days over (e.g., late) from the mean or median number of days for hitting the milestone, the 20 on the y-axis may correspond to being 20 days over from the mean or median number of days for hitting the milestone, and the 30 on the y-axis may correspond to being 30 days over from the mean or median number of days for hitting the milestone.

The units on the x-axis correspond to dates. Specifically, each consecutive line on the x-axis corresponds to 1.5 months. There is a displayed date indicator on the second vertical line corresponding to January 2020, a displayed date indicator on the fourth vertical line corresponding to July 2020 and a displayed date indicator on the sixth vertical line corresponding to January 2021.

User interface 402C also includes indicator key 404C, which indicates that 6-week moving average 406C includes vertical indicators on moving average plot 400C, 3-month moving average 408C includes triangular indicators on moving average plot 400C, 6-month moving average 410C includes square indicators on moving average plot 400C, and 12-month moving average 412C includes circular indicators on moving average plot 400C. For ease of illustration, the thickness of the lines corresponding to the moving averages increases as the speed of moving average decreases (e.g., 12-month moving average 412C is the slowest moving average and has the thickest line, 6-week moving average 406A is the fastest moving average and has the thinnest line).

FIG. 4D illustrates an interactive user interface 402D comprised of the temporal moving average plot of FIG. 4C and an insight 408D associated with the temporal moving average plot of FIG. 4C.

In this example, temporal moving average plot 400D for the combined vector of ClusterGroupType A vector and Manufacturer B vector includes selectable user interface element 406D. In this example, selectable user interface element 406D is a circular object with a diagonal line pattern. However, it should be understood that selectable user interface elements such as selectable user interface element 406D may be displayed in other shapes, colors, or patterns, for example.

In this example, an interaction is received at selectable user interface element 406D. The interaction may comprise a mouse click, a touch input, or a voice input, for example. The interaction causes insight 408D to be displayed. Selectable user interface element 406D is at a location on temporal moving average plot 400D where the fastest moving average (e.g., the 6-week moving average) crosses each of the three slower moving averages from above to below in the positive y-axis of temporal moving average plot 400D. The angle of the crossing is also relatively high (e.g., greater than 45 degrees). Moving average analysis rules provide that in this scenario, lateness in the shorter term is decreasing relative to the longer term, and this is a week signal that timeliness is improving. Thus, insight 408D states: “Lateness in the shorter term is decreasing relative to the longer term. This is a week signal of general improvement.” Insight 408D also states “If this trend continues we may be able to order more servers of ClusterGroupType A from Manufacturer B. Should I set a reminder to check on the status of timeliness for this vector for one month?” There is also a selectable “YES” element for causing the action (e.g., setting the reminder) to be automatically performed by the system, and a selectable “NO” element for declining the recommendation. If the “YES” element is selected, early warning service 122 may cause an electronic reminder object to be added to an electronic calendar associated with a user account that is logged into a computing device displaying interactive user interface 402D. The reminder may be populated with content related to insight 408D. Additionally, selection of the “YES” element may cause early warning service 122 to automatically generate and analyze a new temporal moving average plot for the combined vector of ClusterGroupType A vector and Manufacturer B vector in one month. In additional examples, one or more objects displayed on or associated with interactive user interface 402D may be selectable for causing the identities of one or more locations (e.g., regions, data centers) that receive server clusters of group type A manufactured by Manufacturer B to be displayed.

Thus, early warning service 122 may generate insights and recommendations that may be interacted with for causing actions to be performed that enhance the efficiency of a supply chain. Insight 408D and the included actionable recommendation are simply one example, and it should be understood that other recommendations and action types may be included in insights for a combined cluster group type and manufacturer vector, as well as other types of vectors. Additionally, different insight content and actionable recommendations may be generated and displayed based on the type and/or severity of moving average crossing that an insight and/o recommendation is generated for.

FIG. 5A illustrates a first set of moving average analysis rules 500A that may be applied for analyzing a temporal moving average plot comprised of one or more supply chain vectors where a faster moving average crosses a slower moving average from below to above in the positive y-axis of a temporal moving average plot. In this example, there are four exemplary moving averages. Those moving averages are A, B, C and D. Moving average A is the fastest moving average of the four, moving average B is the second fastest moving average of the four, moving average C is the third fastest moving average of the four, and moving average D is the slowest moving average of the four. Although moving average analysis rules 500A are described in relation to four moving averages it should be understood that they may be applied to more or fewer than four moving averages for a supply chain moving average plot.

Moving average analysis rules 500A include a first operation 502A that may be applied by a moving average engine that is analyzing a moving average plot for one or more supply chain vectors. That is, at first operation 502A, the moving average engine may first determine whether any moving averages crossed in a moving average plot. If so, the moving average engine may determine at operation 503A whether a faster moving average crossed a slower moving average from below to above in the positive y-axis of the moving average plot. If so, the moving average engine may determine at operation 504A which faster moving average crossed which slower moving average.

If at operation 504A a determination is made that moving average A crossed moving average B, the moving average engine may determine at operation 518A that lateness in the shorter term is increasing relative to the longer term. This is a weak signal of a broader issue and it is a potential signal for a breaking, one-off issue if the slope of moving average A is large.

If at operation 504A a determination is made that moving average A crossed moving average C, the moving average engine may determine at operation 520A that lateness in the shorter term is increasing relative to the longer term. This is a weak signal of a broader issue and it is a potential signal for a breaking, one-off issue if the slope of moving average A is large.

If at operation 504A a determination is made that moving average A crossed moving average D, the moving average engine may determine at operation 522A that lateness in the shorter term is increasing relative to the longer term. This is a weak signal of a broader issue and a potential signal for a breaking, one-off issue if the slope of moving average A is large.

If at operation 504A a determination is made that moving average B crossed moving average C, the moving average engine may determine at operation 524A that lateness in the shorter term is increasing relative to the longer term. This is a moderate signal of a broader issue.

If at operation 504A a determination is made that moving average B crossed moving average D, the moving average engine may determine at operation 526A that lateness in the shorter term is increasing relative to the longer term. This is a moderate signal of a broader issue.

If at operation 504A a determination is made that moving average C crossed moving average D, the moving average engine may determine at operation 528A that lateness in the shorter term is increasing relative to the longer term. This is a strong signal of a broader issue.

FIG. 5B illustrates a second set of moving average analysis rules 500B that may be applied for analyzing a temporal moving average plot comprised of one or more supply chain vectors where a faster moving average crosses a slower moving average from above to below in the positive y-axis of a temporal moving average plot. In this example, there are four exemplary moving averages. Those moving averages are A, B, C and D. Moving average A is the fastest moving average of the four, moving average B is the second fastest moving average of the four, moving average C is the third fastest moving average of the four, and moving average D is the slowest moving average of the four. Although moving average analysis rules 500B are described in relation to four moving averages it should be understood that they may be applied to more or fewer than four moving averages for a supply chain moving average plot.

Moving average analysis rules 500B include a first operation 502B that may be applied by a moving average engine that is analyzing a moving average plot for one or more supply chain vectors. That is, at first operation 502B, the moving average engine may first determine whether any moving averages crossed in a moving average plot. If so, the moving average engine may determine at operation 503B whether a faster moving average crossed a slower moving average from above to below in the positive y-axis of the moving average plot. If so, the moving average engine may determine at operation 50B which faster moving average crossed which slower moving average.

If at operation 504B a determination is made that moving average A crossed moving average B, the moving average engine may determine at operation 518B that lateness in the shorter term is decreasing relative to the longer term. This is a weak signal of general improvement.

If at operation 504B a determination is made that moving average A crossed moving average C, the moving average engine may determine at operation 520B that lateness in the shorter term is decreasing relative to the longer term. This is a weak signal of general improvement.

If at operation 504B a determination is made that moving average A cross moving average D, the moving average engine may determine at operation 522B that lateness in the shorter term is decreasing relative to the longer term. This is a weak signal of general improvement.

If at operation 504B a determination is made that moving average B crossed moving average C, the moving average engine may determine at operation 524B that lateness in the shorter term is decreasing relative to the longer term. This is a moderate signal of general improvement.

If at operation 504B a determination is made that moving average B crossed moving average D, the moving average engine may determine at operation 526B that lateness in the shorter term is decreasing relative to the longer term. This is a moderate signal of general improvement.

If at operation 504B a determination is made that moving average C crossed moving average D, the moving average engine may determine at operation 528B that lateness in the shorter term is decreasing relative to the longer term. This is a strong signal of general improvement.

FIG. 6 illustrates an exemplary user interface 602 that may be generated and caused to be displayed by an early warning service 122. Early warning service 122 may make determinations as to durations of time until products in a supply chain may meet supply chain milestones based on the vector analysis and moving average analysis it performs. In this example, user interface 602 corresponds to a data center and server cluster supply chain. However, it should be understood that similar user interfaces may be generated and displayed for other supply chain types.

User interface 602 includes a plurality of dropdown lists that may be utilized to filter which server clusters and data centers to display information for. Specifically, user interface 602 includes dropdown menus for demand ID, resource type, resource grouping, reservation status, priority name, intent, data center (DC), is docketed, region, geo, IFS managed, dock status, live status, and priority rank.

User interface 602 displays demand data 604 corresponding to the selected filters described above. The first column of demand data 604 includes a demand identifier (e.g., a server cluster demand identifier). The second column of demand data 604 includes a region corresponding to the demand identifier. The third column of demand data 604 includes the data center corresponding to the demand identifier. The fourth column of demand data 604 includes a resource type corresponding to the demand identifier. The fifth column of demand data 604 includes a dock status (on-time or late) corresponding to the demand identifier. The sixth column of demand data 604 includes a live status (on-time or late) corresponding to the demand identifier. The seventh column includes a number of days, determined by early warning service 122 based on analysis of one or more supply chain vectors and/or one or more moving average plots associated with those one or more supply chain vectors, until the server clusters corresponding to the demand identifier are estimated to be docked. The eighth column includes a number of days, determined by early warning service 122 based on analysis of one or more supply chain vectors and/or one or more moving average plots associated with those one or more supply chain vectors, until the server clusters corresponding to the demand identifier are estimated to go live. The ninth column includes a date, determined by early warning service 122 based on analysis of one or more supply chain vectors and/or one or more moving average plots associated with those one or more supply chain vectors, when the server clusters corresponding to the demand identifier are estimated to be docked. The tenth column includes a date, determined by early warning service 122 based on analysis of one or more supply chain vectors and/or one or more moving average plots associated with those one or more supply chain vectors, when the server clusters corresponding to the demand identifier are estimated to go live.

In the fifth and sixth columns there is a circle that indicates whether the dock status or the live status is on time or late. In some examples, the circle may be colored red if the status is late. In additional examples, the circle may be colored green if the status is on-time. This is just one example of indicating that the status of a supply chain milestone corresponding to a demand identifier has been determined to have a late status. Other shapes, patterns, and colors may similarly be utilized and displayed in a user interface such as exemplary user interface 602.

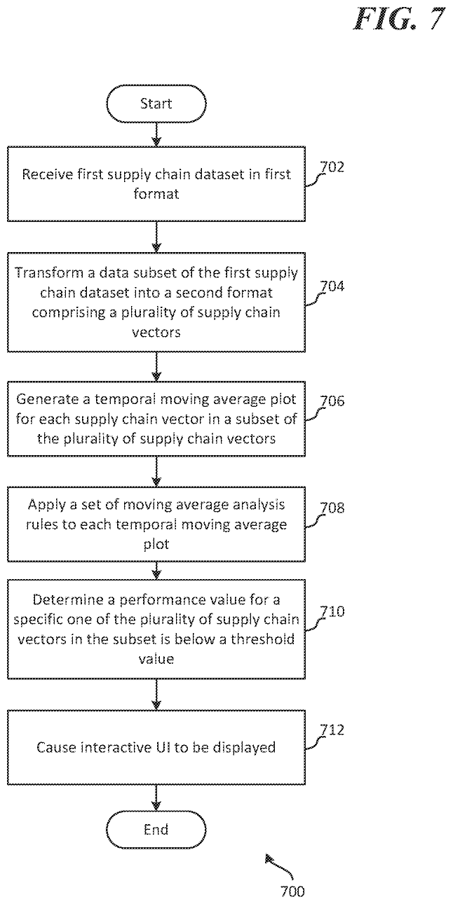

FIG. 7 is an exemplary method 700 for identifying supply chain issues using transformed supply chain data. The method 700 begins at a start operation and flow moves to operation 702.

At operation 702 a first supply chain dataset in a first format is received. The first supply chain dataset comprises a plurality of supply chain dimensions. The first format may comprise a plurality of tables stored across a plurality of files. In some examples, the first format may comprise a flat file or flat database format.

From operation 702 flow continues to operation 704 where a data subset of the first supply chain dataset is transformed into a second format comprising a plurality of supply chain vectors. Each supply chain vector may be associated in the second format with a corresponding demand identifier. For example, data transformation engine 124 may identify a demand identifier and associate a plurality of dimensions that correspond to the demand identifier with the demand identifier in a single file. The dimensions may be identifier from a plurality of files that makeup the supply chain dataset. For example, a first table in a first file from the supply chain dataset may include a first dimensions associated with the demand identifier and a second table in a second file from the supply chain dataset may include a second dimensions associated with the demand identifier. In some examples, data transformation engine 124 may execute one or more SQL queries (e.g., key-based queries) and extract the dimensions that are associated with a demand identifier.

Once a demand identifier has been associated with its supply chain dimensions, values corresponding to the demand identifier may be inserted into one or more of those dimensions and thereby generate a plurality of supply chain vectors. In some examples, data transformation engine 124 may transform two or more vectors into one or more combined vectors. For example, data transformation engine 124 may generate a first vector comprised of a demand identifier, a datacenter region corresponding to that demand identifier, and a manufacturer associated with that demand identifier, and a second vector comprised of the demand identifier, and a specific warehouse associated with the identifier. The data transformation engine may combine those two vectors into a single vector comprised of the demand identifier, the datacenter region corresponding to the demand identifier, the manufacturer associated with the demand identifier, and the specific warehouse associated with the identifier.

Vector relationship models 126 may be applied to the vectors that have been generated. Vector relationship models 126 may comprise one or more linear regression models, statistical enrichment tests, statistical hypothesis tests, information score models, and/or classifier models. The one or more vector relationship models may be applied to supply chain vectors with different dimensions and values/variables related to the different dimensions. In this manner, vector relationship models 126 may analyze hundreds, thousands, or even millions of vectors to determine which dimensions and corresponding variables are the most likely candidates leading to supply chain degradation. In some examples, vector relationship models 126 may output a performance score for each vector, or combined vector, corresponding to a deviance from a mean or median supply chain performance timeframe for a supply chain milestone (e.g., time to manufacture component, time to ship component, time to server cluster installation, time to dock). For example, installation of a server cluster at a specific data center may have a mean or median duration of time that is expected based on historical data. Similarly, manufacture of a component of a device by a particular manufacturer may have a mean of median duration of time that is expected based on historical data.

From operation 704 flow continues to operation 706 where a temporal moving average plot for each supply chain vector in a subset of the plurality of supply chain vectors is generated. The subset may be comprised of vectors that have been determined to have a performance score that is above a threshold divergence from a mean or median supply chain performance timeframe for a supply chain milestone. In some examples, the threshold may vary from supply chain milestone to supply chain milestone. In other examples, the threshold may be the same for one or more supply chain milestones. Each temporal moving average plot may comprise, for a supply chain milestone, at least a first moving average with a first speed (e.g., a fast-moving average) and a second moving average with a second speed (e.g., a slow-moving average). In some examples, each temporal moving average plot may comprise tens, hundreds, or even thousands of different moving averages (e.g., different speeds of averages) for a supply chain milestone.

From operation 706 flow continues to operation 708 where a set of moving average analysis rules is applied to each temporal moving average plot to determine a performance value for each corresponding supply chain vector in the subset. As an example, a first rule may dictate that if a relatively fast-moving average crosses from below to above a relatively slow-moving average in the positive y-axis range, this indicates the lateness for a corresponding supply chain milestone is increasing (e.g., timeliness is worsening). A second rule may dictate that if a relatively fast-moving average crosses from above to below a relatively slow-moving average in the positive y-axis range, this indicates the lateness for a corresponding supply chain milestone is decreasing (e.g., timeliness is improving). A third rule may dictate that if a relatively fast-moving average crosses from below to above a relatively slow-moving average in the negative y-axis range, this indicates the earliness for a corresponding supply chain milestone is decreasing (e.g., timeliness is improving). A fourth rule may dictate that if a relatively fast-moving average crosses from above to below a relatively slow-moving average in the negative y-axis range, this indicates the earliness is increasing (e.g., timeliness is worsening). Additionally, a large slope of a moving average is a stronger signal than a smaller slope.

From operation 708 flow continues to operation 710 where a determination is made, based on application of the set of moving average analysis rules, that a performance value for a specific one of the plurality of supply chain vectors in the subset of the plurality of supply chain vectors is below a threshold value. In some examples, the threshold value may comprise a number of days (e.g., 10 days, 20 days, 50 days, 100 days). In additional examples, the threshold may be the same or different for various supply chain milestones.

From operation 710 flow continues to operation 712 where an interactive user interface is caused to be displayed. The interactive user interface indicates the performance value for the specific one of the plurality of supply chain vectors is below the threshold value. In some examples, the interactive user interface may comprise one or more insights and/or supply chain recommendations. The one or more insights or recommendations may correspond to one or more vectors, or combined vectors, and their associated temporal moving average plot(s) that have been determined to affect the timeliness of a supply chain milestone. In some examples, a displayed insight may comprise a temporal moving average plot for a vector and a description of one or more datapoints that have been determined to be a cause or likely cause of a degradation in timeliness related to a supply chain milestone.

From operation 712 flow moves to an end operation and the method 700 ends.

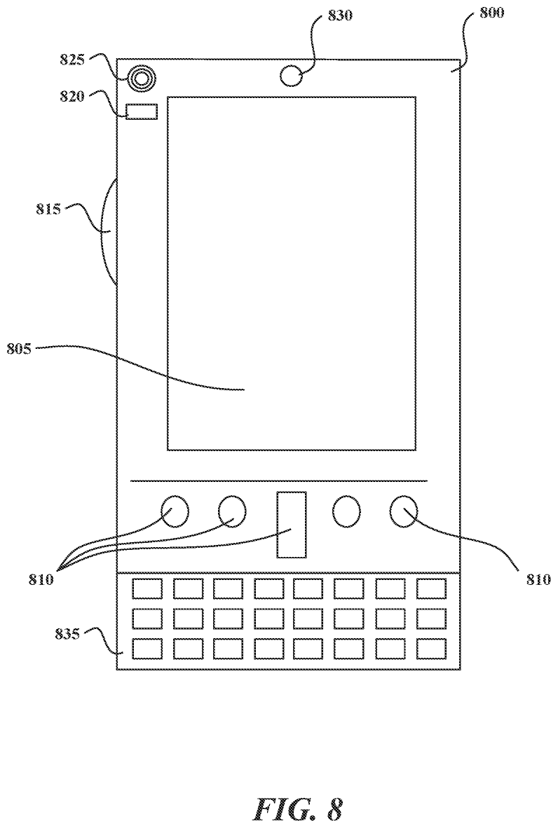

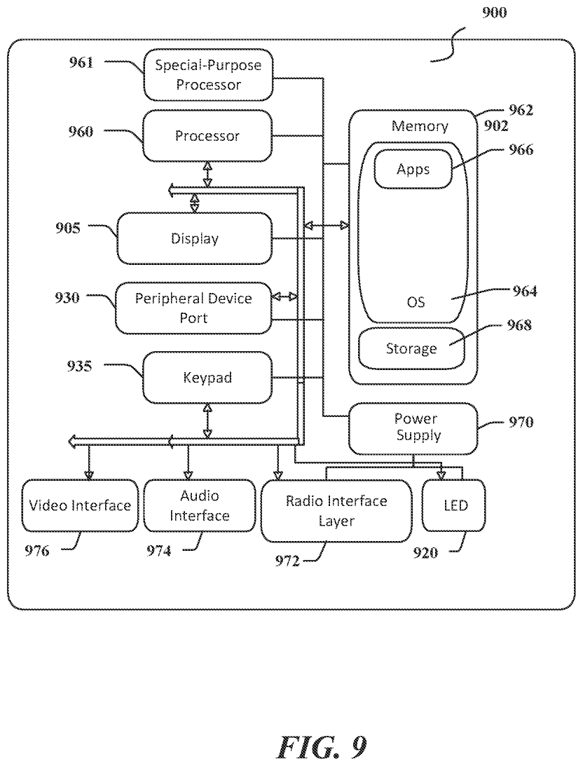

FIGS. 8 and 9 illustrate a mobile computing device 800, for example, a mobile telephone, a smart phone, wearable computer (such as smart eyeglasses), a tablet computer, an e-reader, a laptop computer, or other AR compatible computing device, with which embodiments of the disclosure may be practiced. With reference to FIG. 8, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or fewer input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 9 is a block diagram illustrating the architecture of one aspect of a mobile computing device. That is, the mobile computing device 900 can incorporate a system (e.g., an architecture) 902 to implement some aspects. In one embodiment, the system 902 is implemented as a “smart phone” capable of running one or more applications (e.g., browser, e-mail, calendaring, contact managers, messaging clients, games, and media clients/players). In some aspects, the system 902 is integrated as a computing device, such as an integrated personal digital assistant (PDA) and wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as e-mail or other messages used by an e-mail application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900, including instructions for providing and operating a cloud forecast application.

The system 902 has a power supply 970, which may be implemented as one or more batteries. The power supply 970 might further include an external power source, such as an AC adapter or a powered docking cradle that supplements or recharges the batteries.

The system 902 may also include a radio interface layer 972 that performs the function of transmitting and receiving radio frequency communications. The radio interface layer 972 facilitates wireless connectivity between the system 902 and the “outside world,” via a communications carrier or service provider. Transmissions to and from the radio interface layer 972 are conducted under control of the operating system 964. In other words, communications received by the radio interface layer 972 may be disseminated to the application programs 966 via the operating system 964, and vice versa.

The visual indicator 820 may be used to provide visual notifications, and/or an audio interface 974 may be used for producing audible notifications via the audio transducer 825. In the illustrated embodiment, the visual indicator 820 is a light emitting diode (LED) and the audio transducer 825 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 825, the audio interface 974 may also be coupled to a microphone to receive audible input, such as to facilitate a telephone conversation. In accordance with embodiments of the present disclosure, the microphone may also serve as an audio sensor to facilitate control of notifications, as will be described below. The system 902 may further include a video interface 976 that enables an operation of an on-board camera 830 to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9 by the non-volatile storage area 968.

Data/information generated or captured by the mobile computing device 900 and stored via the system 902 may be stored locally on the mobile computing device 900, as described above, or the data may be stored on any number of storage media that may be accessed by the device via the radio interface layer 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio interface layer 972 or via a distributed computing network. Similarly, such data/information may be readily transferred between computing devices for storage and use according to well-known data/information transfer and storage means, including electronic mail and collaborative data/information sharing systems.

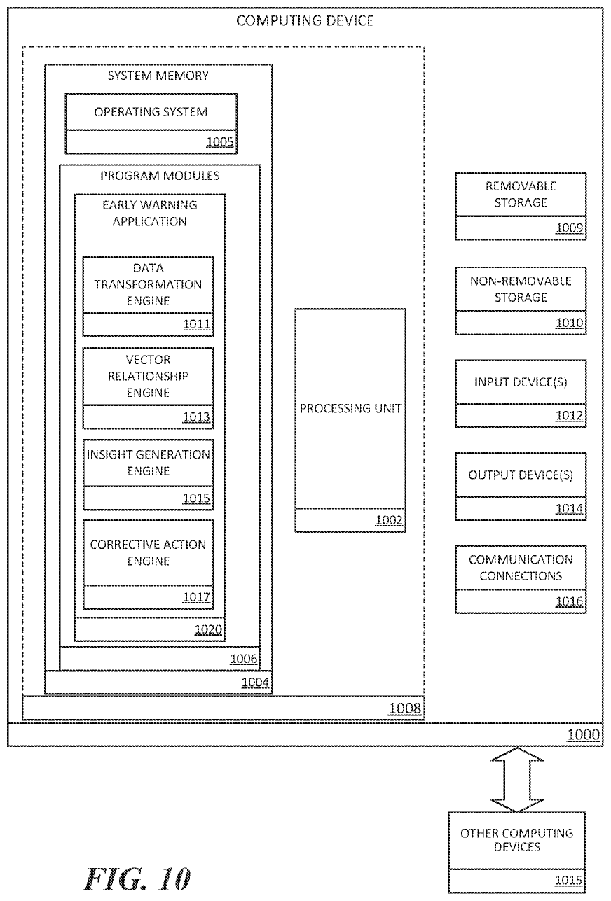

FIG. 10 is a block diagram illustrating physical components (e.g., hardware) of a computing device 1000 with which aspects of the disclosure may be practiced. The computing device components described below may have computer executable instructions for identifying supply chain issues using transformed supply chain data. In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories. The system memory 1004 may include an operating system 1005 suitable for running one or more cloud forecast applications. The operating system 1005, for example, may be suitable for controlling the operation of the computing device 1000. Furthermore, embodiments of the disclosure may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006 (e.g., early warning application 1020) may perform processes including, but not limited to, the aspects, as described herein. According to examples, data transformation engine 1011 may perform operations associated with transforming supply chain data from a first format (e.g., multiple files, multiple tables) into a second format (e.g., a single file, supply chain vectors). Vector relationship engine 1013 may perform operations associated with applying linear regression models, statistical hypothesis tests, enrichment tests, information score models, and/or classifier models to transformed supply chain data to identify relationships between supply chain dimensions and supply chain efficiency or inefficiency. Insight generation engine 1015 may generate insights and recommendations related to supply chain vectors. Those insights and recommendations may be displayed and interacted with. Corrective action engine 1017 may execute operations for remedying the lateness associated with a supply chain milestone based on the analysis performed by moving average models.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1000 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1000 may also have one or more input device(s) 1012 such as a keyboard, a mouse, a pen, a sound or voice input device, a touch or swipe input device, etc. The output device(s) 1014 such as a display, speakers, a printer, etc. may also be included. The aforementioned devices are examples and others may be used. The computing device 1000 may include one or more communication connections 1016 allowing communications with other computing devices 1050. Examples of suitable communication connections 1016 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer readable media and computer storage media as described herein does not include transitory media such as a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

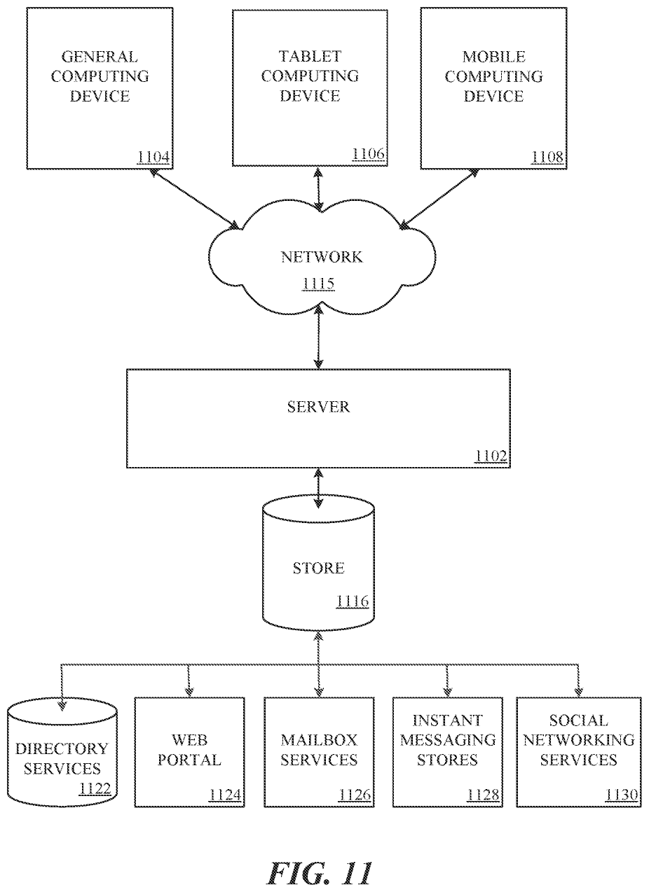

FIG. 11 illustrates one aspect of the architecture of a system for processing data received at a computing system from a remote source, such as a personal/general computer 1104, tablet computing device 1106, or mobile computing device 1108, as described above. Content displayed at server device 1102 may be stored in different communication channels or other storage types. For example, various documents may be stored using a directory service 1122, a web portal 1124, a mailbox service 1126, an instant messaging store 1128, or a social networking site 1130. The program modules 1006 may be employed by a client that communicates with server device 1102, and/or the program modules 1006 may be employed by server device 1102. The server device 1102 may provide data to and from a client computing device such as a personal/general computer 1104, a tablet computing device 1106 and/or a mobile computing device 1108 (e.g., a smart phone) through a network 1115. By way of example, the computer system described above may be embodied in a personal/general computer 1104, a tablet computing device 1106 and/or a mobile computing device 1108 (e.g., a smart phone). Any of these embodiments of the computing devices may obtain content from the store 1116, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure. The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer-implemented method for identifying supply chain issues using transformed supply chain data, the computer-implemented method comprising:
receiving a first supply chain dataset in a first format, the first supply chain dataset comprising a plurality of supply chain dimensions;
transforming a data subset of the first supply chain dataset into a second format comprising a plurality of supply chain vectors;
generating a temporal moving average plot for each supply chain vector in a subset of the plurality of supply chain vectors;
applying a set of moving average analysis rules to each temporal moving average plot to determine a performance value for each corresponding supply chain vector in the subset;
determining, based on application of the set of moving average analysis rules, that a performance value for a specific one of the plurality of supply chain vectors in the subset of the plurality of supply chain vectors is below a threshold value; and
causing an interactive user interface to be displayed, the interactive user interface indicating the performance value for the specific one of the plurality of supply chain vectors is below the threshold value.

2. The computer-implemented method of claim 1, wherein:
the first format comprises a flat file format; and
the first supply chain dataset is maintained in a plurality of tables and a plurality of files.

3. The computer-implemented method of claim 2, wherein transforming the data subset comprises applying a SQL query to the plurality of tables to generate a single flat file from the plurality of files.

4. The computer-implemented method of claim 3, wherein the single flat file comprises:
a demand identifier and a plurality of supply chain vectors that are specific to the demand identifier, wherein each supply chain vector that is specific to the demand identifier comprises at least one value for one or more supply chain dimensions that are specific to the demand identifier.

5. The computer-implemented method of claim 1, wherein transforming the data subset comprises:
combining a first vector comprised of a first value for a first one of the supply chain dimensions with a second vector comprised of a second value for a second one of the supply chain dimensions.

6. The computer-implemented method of claim 1, further comprising:
applying at least one of a linear regression model and statistical enrichment test to the plurality of supply chain vectors; and
identifying, based on application of at least one of the linear regression model and the statistical enrichment test, the subset of the plurality of supply chain vectors.

7. The computer-implemented method of claim 1, wherein:
a temporal moving average plot for a supply chain vector in the subset of the plurality of supply chain vectors comprises at least a first moving average for the supply chain vector and a second moving average for the supply chain vector; and
the first moving average is faster moving that the second moving average.

8. The computer-implemented method of claim 1, wherein the set of moving average analysis rules dictate that:
a performance value for a supply chain vector is decreasing over time when a fast-moving average vector in a temporal moving average plot for the supply chain vector crosses a slow-moving average vector from below to above the slow-moving average vector in a positive y-axis range;
the performance value for the supply chain vector is increasing over time when the fast-moving average vector in the temporal moving average plot for the supply chain vector crosses a slow-moving average vector from above to below the slow-moving average vector in a positive y-axis range;
the performance value for the supply chain vector is increasing over time when the fast-moving average vector in the temporal moving average plot for the supply chain vector crosses the slow-moving average vector from below to above the slow-moving average vector in a negative y-axis range; and
the performance value for the supply chain vector is decreasing over time when the fast-moving average vector in the temporal moving average plot for the supply chain vector crosses a slow-moving average vector from above to below the slow-moving average vector in a negative y-axis range.

9. The computer-implemented method of claim 8, wherein the set of moving average analysis rules further dictate that a slope of the fast-moving average vector when it crosses the slow-moving average vector corresponds to a severity of the change in the performance value decreasing over time or increasing over time.

10. The computer-implemented method of claim 9, wherein the interactive user interface includes a description of one or more of the set of moving average analysis rules that were applied to determine the performance value for the specific one of the plurality of supply chain vectors in the subset of the plurality of supply chain vectors.

11. The computer-implemented method of claim 1, wherein the second format comprises a single flat file with a demand identifier, and wherein the demand identifier corresponds to:
a specific data center;
a number of ordered server racks to be operational at the specific data center on a specific date;
a manufacturer of the server racks.

12. The computer-implemented method of claim 11, wherein the plurality of supply chain dimensions comprise:
a timeframe associated with the demand identifier;
a physical location associated with the demand identifier;
a hardware type associated with the demand identifier;
an intent or deployment type associated with the demand identifier;
an execution system associated with the demand identifier; and
a demand significance associated with the demand identifier.

13. A system for identifying supply chain issues, comprising:
a memory for storing executable program code; and
a processor, functionally coupled to the memory, the processor being responsive to computer-executable instructions contained in the program code and operative to:
receive a first supply chain dataset in a first format, the first supply chain dataset comprising a plurality of supply chain dimensions;
transform a data subset of the first supply chain dataset into a second format comprising a plurality of supply chain vectors;
generate a temporal moving average plot for each supply chain vector in a subset of the plurality of supply chain vectors;
apply a set of moving average analysis rules to each temporal moving average plot to determine a performance value for each corresponding supply chain vector in the subset;
determine, based on application of the set of moving average analysis rules, that a performance value for a specific one of the plurality of supply chain vectors in the subset of the plurality of supply chain vectors is below a threshold value; and
cause an interactive user interface to be displayed, the interactive user interface indicating the performance value for the specific one of the plurality of supply chain vectors is below the threshold value.

14. The system of claim 13, wherein:
the first format comprises a flat file format; and
the first supply chain dataset is maintained in a plurality of tables and a plurality of files.

15. The system of claim 14, wherein in transforming the data subset, the processor is further responsive to the computer-executable instructions contained in the program code and operative to:
apply a SQL query to the plurality of tables to generate a single flat file from the plurality of files.

16. The system of claim 13, wherein in transforming the data subset, the processor is further responsive to the computer-executable instructions contained in the program code and operative to:
combine a first vector comprised of a first value for a first one of the supply chain dimensions with a second vector comprised of a second value for a second one of the supply chain dimensions.

17. The system of claim 13, wherein the set of moving average analysis rules dictate that:
a performance value for a supply chain vector is decreasing over time when a fast-moving average vector in a temporal moving average plot for the supply chain vector crosses a slow-moving average vector from below to above the slow-moving average vector in a positive y-axis range;
the performance value for the supply chain vector is increasing over time when the fast-moving average vector in the temporal moving average plot for the supply chain vector crosses a slow-moving average vector from above to below the slow-moving average vector in a positive y-axis range;
the performance value for the supply chain vector is increasing over time when the fast-moving average vector in the temporal moving average plot for the supply chain vector crosses the slow-moving average vector from below to above the slow-moving average vector in a negative y-axis range; and
the performance value for the supply chain vector is decreasing over time when the fast-moving average vector in the temporal moving average plot for the supply chain vector crosses a slow-moving average vector from above to below the slow-moving average vector in a negative y-axis range.

18. A computer-readable storage device comprising executable instructions that, when executed by a processor, assist with identifying supply chain issues using transformed supply chain data, the computer-readable storage device including instructions executable by the processor for:
receiving a first supply chain dataset in a first format, the first supply chain dataset comprising a plurality of supply chain dimensions;
transforming a data subset of the first supply chain dataset into a second format comprising a plurality of supply chain vectors;
generating a temporal moving average plot for each supply chain vector in a subset of the plurality of supply chain vectors;
applying a set of moving average analysis rules to each temporal moving average plot to determine a performance value for each corresponding supply chain vector in the subset;
determining, based on application of the set of moving average analysis rules, that a performance value for a specific one of the plurality of supply chain vectors in the subset of the plurality of supply chain vectors is below a threshold value; and
causing an interactive user interface to be displayed, the interactive user interface indicating the performance value for the specific one of the plurality of supply chain vectors is below the threshold value.

19. The system of claim 18, wherein in transforming the data subset, the instructions are further executable by the processor for:
combining a first vector comprised of a first value for a first one of the supply chain dimensions with a second vector comprised of a second value for a second one of the supply chain dimensions.

20. The system of claim 18, wherein the instructions are further executable by the processor for:
applying a linear regression model to the plurality of supply chain vectors; and
identifying, based on application of the linear regression model, the subset of the plurality of supply chain vectors.
